(19) United States
(12) Patent Application Publication
(10) Pub. No.: US 2019/0300328 A1
(43) Pub. Date: Oct. 3, 2019

(54) SUPER GROUP DISPATCHING

(71) Applicant: OTIS ELEVATOR COMPANY, Farmington, CT (US)

(72) Inventors: Jannah A. Stanley, Portland, CT (US); Daniel S. Williams, Southington, CT (US); Wade A. Montague, Southington, CT (US)

(21) Appl. No.: 15/940,014

(22) Filed: Mar. 29, 2018

(51) Int. Cl. B66B 1/24; B66B 1/46; B66B 1/34

(52) U.S. Cl. CPC B66B 1/2458; B66B 1/468; B66B 1/3407; B66B 2201/4661; B66B 2201/405; B66B 2201/403; B66B 2201/401

(57) ABSTRACT

A method of operating a building elevator system within a building having a plurality of floors is provided. The method including: controlling a building elevator system comprising a first elevator system having a first elevator car, a second elevator system having a second elevator car, and a third elevator system having a third elevator car, the first elevator car is configured to serve a plurality of floors within a first sector, the second elevator car is configured to serve a plurality of floors within a second sector, and the third elevator car is configured to serve a plurality of floors within the first sector and the second sector; detecting at least one of a time of day, an intensity of traffic between the first sector and the second sector, and an intensity of traffic within each sector; and assigning the third elevator car to the first sector or second sector.

### BACKGROUND

The subject matter disclosed herein relates generally to the field of elevator systems, and specifically to a method and apparatus for coordinating the operation of multiple elevator cars.

Commonly, elevator cars are organized into groups serving sectors of a building rather than each elevator car serving the overall length of an elevator shaft to service every floor of a building. Once established, sectors typically remain unchanged due to physical constraints in the elevator system.

### BRIEF SUMMARY

According to an embodiment, a method of operating a building elevator system within a building having a plurality of floors is provided. The method including: controlling a building elevator system comprising a first elevator system having a first elevator car, a second elevator system having a second elevator car, and a third elevator system having a third elevator car, the first elevator car is configured to serve a plurality of floors within a first sector, the second elevator car is configured to serve a plurality of floors within a second sector, and the third elevator car is configured to serve a plurality of floors within the first sector and the second sector; detecting at least one of a time of day, an intensity of traffic between the first sector and the second sector, and an intensity of traffic within each of the first sector and the second sector; and assigning the third elevator car to the first sector or the second sector in response to at least one of the time of day, the intensity of traffic between the first sector and the second sector, and the intensity of traffic within each of the first sector and the second sector.

In addition to one or more of the features described herein, or as an alternative, further embodiments may include: receiving an elevator call from a floor of the plurality of floors within the first sector; and moving the third elevator car to the floor of the plurality of floors within the first sector.

In addition to one or more of the features described herein, or as an alternative, further embodiments may include: receiving an elevator call from a floor of the plurality of floors within the second sector; and moving the third elevator car to the floor of the plurality of floors within the second sector.

In addition to one or more of the features described herein, or as an alternative, further embodiments may include that the plurality of floors of the first sector does not include any floors within the plurality of floors of the second sector with the exception of at least one of an exit floor and transfer floor.

In addition to one or more of the features described herein, or as an alternative, further embodiments may include that the plurality of floors of the first sector includes one or more floors within the plurality of floors of the second sector.

In addition to one or more of the features described herein, or as an alternative, further embodiments may include: receiving an elevator call from a floor of the plurality of floors within the first sector; determining that the first elevator car assigned to the first sector is excluded from serving the floor of the plurality of floors within the first sector; and moving the third elevator car to the floor of the plurality of floors within the first sector.

In addition to one or more of the features described herein, or as an alternative, further embodiments may include: receiving an elevator call from a floor of the plurality of floors within the first sector; determining that the first elevator car assigned to the first sector will not arrive at the floor of the plurality of floors within the first sector within a first selected time period, the first elevator car assigned to the first sector will arrive at the floor of the plurality of floors within the first sector after the third elevator car, or utilizing the first elevator car will result in a longer time to a final destination in comparison to the third elevator car; and moving the third elevator car to the floor of the plurality of floors within the first sector.

In addition to one or more of the features described herein, or as an alternative, further embodiments may include: receiving an elevator call from a floor of the plurality of floors within the first sector; determining that the first elevator call was sent from a person designated as a VIP; and moving the third elevator car to the floor of the plurality of floors within the first sector.

In addition to one or more of the features described herein, or as an alternative, further embodiments may include: receiving an elevator call from a floor of the plurality of floors within the first sector; determining that the first elevator call was sent from a person designated as a VIP; determining whether the first elevator car or the third elevator car will arrive at the floor of the plurality of floors within the first sector first; moving the first elevator car to the floor of the plurality of floors within the first sector when it is determined that the first elevator car will arrive at the floor of the plurality of floors within the first sector first; and moving the third elevator car to the floor of the plurality of floors within the first sector when it is determined that the third elevator car will arrive at the floor of the plurality of floors within the first sector first.

In addition to one or more of the features described herein, or as an alternative, further embodiments may include: assigning the third elevator car to the first sector in response to at least one of the time of day, the intensity of traffic between the first sector and the second sector, and the intensity of traffic within each of the first sector and the second sector.

In addition to one or more of the features described herein, or as an alternative, further embodiments may include: assigning the third elevator car to the second sector in response to at least one of the time of day, the intensity of traffic between the first sector and the second sector, and the intensity of traffic within each of the first sector and the second sector.

According to another embodiment, a control system of a building elevator system is provided. The control system including: a processor; a memory comprising computer-executable instructions that, when executed by the processor, cause the processor to perform operations. The operations including: controlling a building elevator system comprising a first elevator system having a first elevator car, a second elevator system having a second elevator car, and a third elevator system having a third elevator car, wherein the first elevator car is configured to serve a plurality of floors within a first sector, the second elevator car is configured to serve a plurality of floors within a second sector, and the third elevator car is configured to serve a plurality of floors within the first sector and the second sector; detecting at least one of a time of day, an intensity of traffic between the first sector and the second sector, and an intensity of traffic within each of the first sector and the second sector; and assigning the third elevator car to the first sector or second sector in response to at least one of the time of day, the intensity of traffic between the first sector and the second sector, and the intensity of traffic within each of the first sector and the second sector.

In addition to one or more of the features described herein, or as an alternative, further embodiments may include: receiving an elevator call from a floor of the plurality of floors within the first sector; and moving the third elevator car to the floor of the plurality of floors within the first sector.

In addition to one or more of the features described herein, or as an alternative, further embodiments may include: receiving an elevator call from a floor of the plurality of floors within the second sector; and moving the third car to the floor of the plurality of floors within the second sector.

In addition to one or more of the features described herein, or as an alternative, further embodiments may include that the plurality of floors of the second sector does not include any floors within the plurality of floors within the first sector with the exception of at least one of an exit floor and transfer floor.

In addition to one or more of the features described herein, or as an alternative, further embodiments may include that the plurality of floors of the first sector includes one or more floors within the plurality of floors of the second sector.

In addition to one or more of the features described herein, or as an alternative, further embodiments may include: receiving an elevator call from a floor of the plurality of floors within the first sector; determining that the first elevator car assigned to the first sector is excluded from serving the floor of the plurality of floors within the first sector; and moving the third elevator car to the floor of the plurality of floors within the first sector.

In addition to one or more of the features described herein, or as an alternative, further embodiments may include: receiving an elevator call from a floor of the plurality of floors within the first sector; determining that the first elevator car assigned to the first sector will not arrive at the floor of the plurality of floors within the first sector within a first selected time period, the first elevator car assigned to the first sector will arrive at the floor of the plurality of floors within the first sector after the third elevator car, or utilizing the first elevator car will result in a longer time to a final destination in comparison to the third elevator car; and moving the third elevator car to the floor of the plurality of floors within the first sector.

In addition to one or more of the features described herein, or as an alternative, further embodiments may include: receiving an elevator call from a floor of the plurality of floors within the first sector; determining that the first elevator call was sent from a person designated as a VIP; and moving the third elevator car to the floor of the plurality of floors within the first sector.

In addition to one or more of the features described herein, or as an alternative, further embodiments may include: receiving an elevator call from a floor of the plurality of floors within the first sector; determining that the first elevator call was sent from a person designated as a VIP; determining whether the first elevator car or the third elevator car will arrive at the floor of the plurality of floors of the first sector first; moving the first elevator car to the floor of the plurality of floors of the first sector when it is determined that the first elevator car will arrive at the floor of the plurality of floors of the first sector first; and moving the third elevator car to the floor of the plurality of floors of the first sector when it is determined that the third elevator car will arrive at the floor of the plurality of floors of the first sector first.

Technical effects of embodiments of the present disclosure include dividing an elevator's operational route into sectors based upon contiguous floors and reassigning elevator cars to sectors in response to elevator call traffic.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates a schematic view of a building elevator system, in accordance with an embodiment of the disclosure; and

FIG. 3 is a flow chart of method of operating a building elevator system, in accordance with an embodiment of the disclosure.

### DETAILED DESCRIPTION

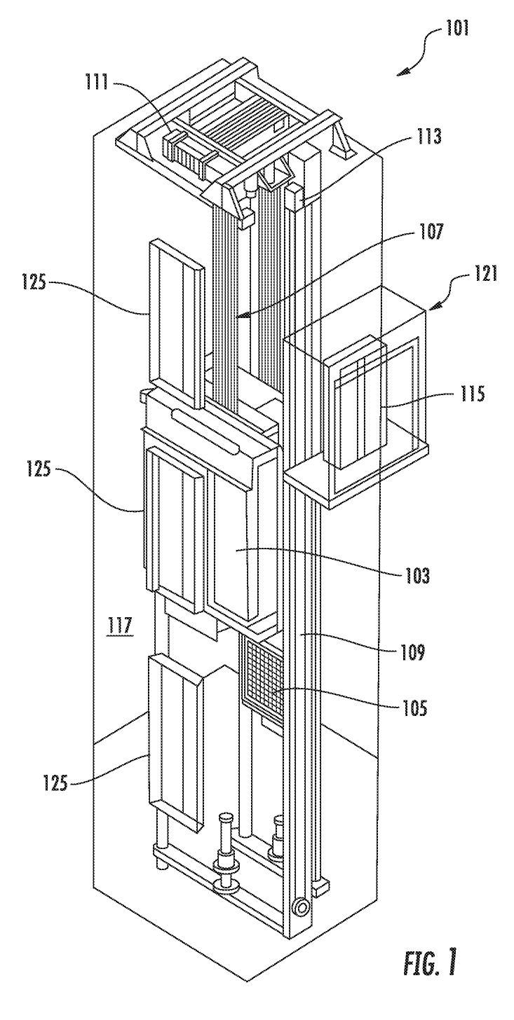

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

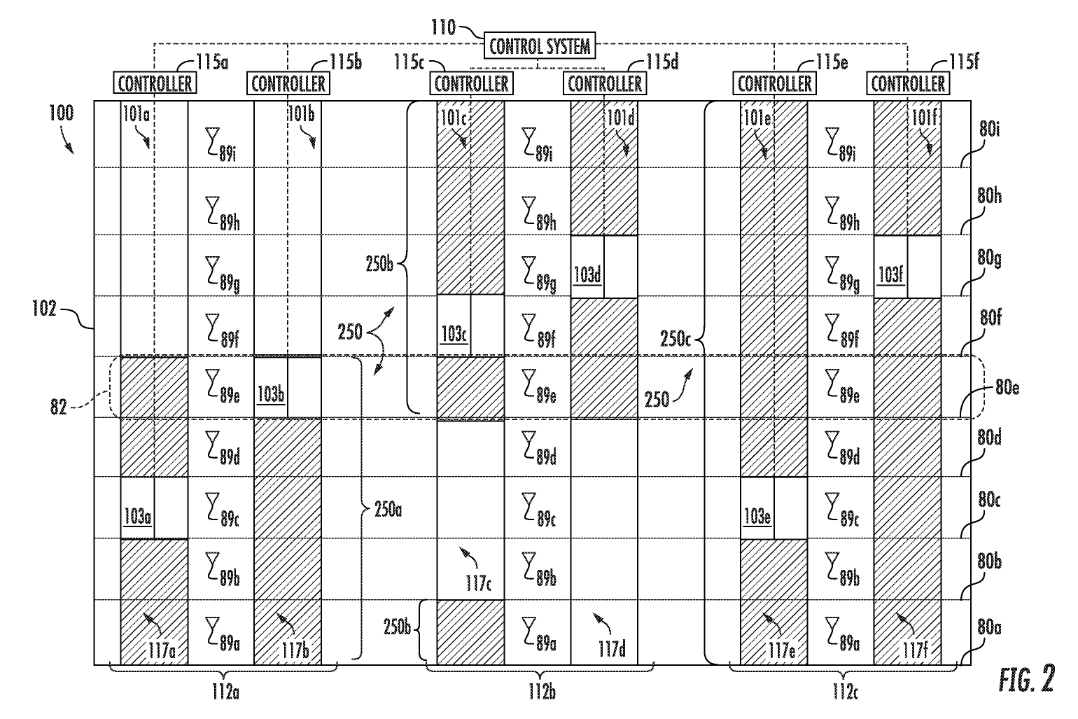

Referring now to FIG. 2 with continued reference to FIG. 1. As seen in FIG. 2, a building elevator system 100 within a building 102 may include multiple different individual elevators systems 101a-101f organized in elevator groups 112a-112c. It is understood that while six elevator systems 101a-101f are utilized for exemplary illustration, embodiments disclosed herein may be applied to building elevator systems 100 having two or more elevator systems 101. It is also understood that while nine floors 80a-80i are utilized for exemplary illustration, embodiments disclosed herein may be applied to building elevator systems 100 having any number of floors.

Further, the elevator system 101a-101f illustrated in FIG. 2 is organized in to three elevator groups 112a-112c for ease of explanation and the elevator systems 101a-101f organized into one or more groups. Each elevator group 112a-112c may contain one or more elevator systems 101. During normal operation, a first elevator group 112a serves a first sector 250a (i.e., a lower sector) comprising floors 80a-80e. During normal operation, a second elevator group 112b serves a second sector 250b (i.e., a higher sector) comprising floors 80e-80i. During normal operation, a third elevator group 112c serves a third sector 250c (i.e., an entire building sector) comprising floors 80a-80i. It is understood that while each elevator group 112a-112c serves only one sector 250 for exemplary illustration, embodiments disclosed herein may include elevator groups having multiple elevator systems where each elevator system in a single elevator group serves a different sector.

Each floor 80a-80i in the building 102 of FIG. 2 may have a destination entry device 89a-89i. The elevator destination entry device 89a-89i sends an elevator call to the control system 110 including the source of the elevator call and the destination of the elevator call. The destination entry device 89a-89i may serve one or more elevator groups 112a-112c or there may be a destination entry device 89a-89i for each elevator group 112a-112c. The destination entry device 89a-89i may be a push button and/or a touch screen and may be activated manually or automatically. For example, the elevator call may be sent by an individual entering the elevator call via the destination entry device 89a-89i. The destination entry device 89a-89i may also be activated to send an elevator call by voice recognition or a passenger detection mechanism in the hallway, such as, for example a weight sensing device, a visual recognition device, and a laser detection device. The destination entry device 89a-89i may be activated to send an elevator call through an automatic elevator call system that automatically initiates an elevator call when an individual is determined to be moving towards the elevator system in order to call an elevator or when an individual is scheduled to activate the destination entry device 89a-89i.

The control system 110 is operably connected to the controller 115a-115f of each elevator system 101a-101f. The controllers 115a-115f can be combined, local, remote, cloud, etc. The control system 110 is configured to the control and coordinate operation of multiple elevator system 101a-101f. The control system 110 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The control system 110 is configured to organize the elevator floors 80a-80i into one or more sectors 250 and each elevator car 103a-103f may be applied to transport individuals within a specific sector 250. Each sector 250 may be made up of a group of contiguous floors. In an example, the control system 110 may organize the elevator floors 80b-80i into a first sector 250a that includes floors 80a-80e, a second sector 250b that includes floors 80e-80i, and a third sector 250c that serves floors 80a-80i. The first sector 250a and the second sector 250b may overlap at a transfer floor 82 (e.g., sky lobby). Buildings may have multiple transfer floors that allow passengers to transfer from an elevator system serving one sector to another elevator system serving another sector. In the example illustrated in FIG. 2, passengers may enter the building 102 a floor 80a, board an elevator car 103a, 103b in the first group 112a that serves the first sector 250a (i.e. lower sector) take the elevator car 103a, 103b up to the transfer floor 82 and then board an elevator car 103c, 103d in the second group 112b that serves the second sector 250b (i.e. upper sector) to travel to any floor 80f-80i in the second sector 250b. Alternatively rather than utilizing the transfer floor 82, elevator calls between the first sector 250a and the second sector 250b may be handled by the third group 112c of elevator cars 103e, 103f that serve both the first sector 250a and the second sector 250b (i.e., third sector 250c), which advantageously reduces the number of elevator trips from two to one.

In an embodiment, the control system 110 may organize the floors 80a-80i into sectors 250 in response to a usage of the building elevator system 100. Alternatively, there may be physical constraints that differentiate the sectors 250. For example, elevator systems 101a, 101b may stop at floor 80e and may not physically be able to go any higher; elevator systems 101c, 101d may be able to go from top to bottom but there may be no doors on floors 80d-b; and only elevator systems 101e, 101f have the ability to serve all floors. The elevator systems 101 may be dynamically assigned to sectors. For example, an elevator car 103 of an elevator system 101 may serve one call in one sector and then immediately serve another elevator call in another sector. One or more elevator cars 103 may be assigned to a single sector 250. Each sector 250 may contain a different number of floors 80a-80i. The control system 110 can create any number of sectors 250 and the control system 110 may assign any elevator system 101a-101f to any sector to help with additional traffic in a particular sector. For example, the controller may re-assign elevator systems 101e, 101f currently serving the entire building 102 via the third sector 250c to the first sector 250a when traffic becomes high in the first sector 250a.

The control system 110 is configured to create and/or adjust the sectors 250 in response to sector parameters including but not limited to a time of day, an intensity of traffic between sectors 250, and an intensity of traffic within each sector 250. The control system 110 is configured to adjust at least one of the number of sectors 250, the number of floors 80a-80i in each sector 250, and the number of elevator systems 101 assigned to each sector 250 in response to the sector parameter listed above. The control system 110 may also be configured to create and/or adjust the sectors 250 based upon a status level of a passenger. For example, a sector 250 may be adjusted in order to reduce the elevator wait time for a very important person (VIP) passenger who needs to get to their destination floor faster than the remaining passenger population (e.g. a doctor heading to an emergency situation on a floor, or CEO of a company whose time may be limited).

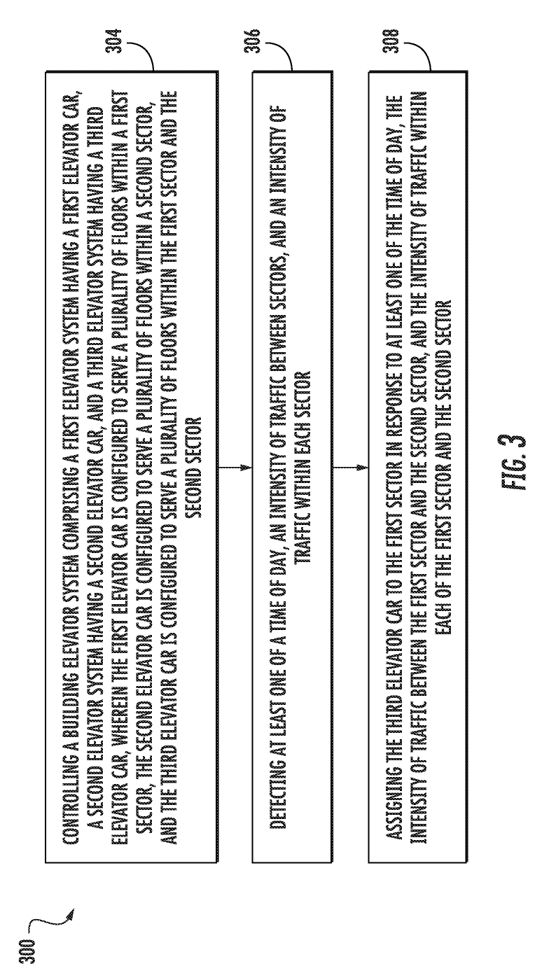

Referring now to FIG. 3, while referencing components of FIGS. 1 and 2. FIG. 3 shows a flow chart of method 300 of operating a building elevator system 100 within a building 102 having a plurality of floors 80a-80i, in accordance with an embodiment of the disclosure. At block 304, the building elevator system 100 is under normal operation. Under normal operation, the control system 110 is controlling the first elevator system 101a and the second elevator system 101c. The building elevator system 100 comprises a first elevator system 101a having a first elevator car 103a, a second elevator system 101c having a second elevator car 103c, and a third elevator system 101d having a third elevator car 103e. The first elevator car 103a, the second elevator car 103c, and the third elevator car 103e are configured to serve a plurality of floors 80a-80i but may be assigned to serve a specific sector of floors. For example, the first elevator car 103a is assigned to serve a plurality of floors 80a-80e within a first sector 250a (i.e., lower portion of the building 102), the second elevator car 103c is assigned to serve a plurality of floors 80e-80i within a second sector 250b (i.e., upper portion of the building 102), and the third elevator car 103e is configured to serve a plurality of floors 80a-80i within the first sector 250a and the second sector 250b (i.e., entire building 102 or third sector 250c).

At block 306, at least one of a time of day, an intensity of traffic between the first sector and the second sector, and an intensity of traffic within each of the first sector and the second sector is detected. For example, one sector may experience high traffic during specific time of day, thus elevator cars in that sector may need assistance from elevator cars in other sectors experiencing low traffic during that specific time of day.

In an embodiment, the plurality of floors 80a-80e of the first sector 250a does not include any floors within the plurality of floors 80f-80i of the second sector 250b, thus no transfer floor exists. In an embodiment, the plurality of floors 80a-80e of the first sector includes contiguous floors of the plurality of floors 80a-80i. In an embodiment, the plurality of floors 80e-80i of the second sector 250b includes contiguous floors of the plurality of floors 80a-80i.

At block 308, the third elevator car 103e is assigned to the first sector 250a in response to at least one of the time of day, the intensity of traffic between the first sector 250a and the second sector 250b, and the intensity of traffic within each of the first sector 250a and the second sector 250b. For example, if it is determined that the first sector 250a is experiencing higher than normal traffic while the third sector 250c is experiencing low traffic, then the third elevator car 103e currently serving the third sector 250c may be assigned to the first sector 250a to help. Thus, when an elevator call is received from a floor of the plurality of floors within the first sector 250a, the third elevator car 103e may be moved to the floor of the plurality of floors within the first sector 250a. In an embodiment, the third elevator car 103e may only be moved to the floor of the plurality of floors 80a-80e within the first sector 250a if it is determined that the first elevator car 103a also assigned to the first sector 250a is excluded (i.e. ineligible) of the plurality of floors within the first sector 250a.

The first elevator car 103a may become excluded (i.e. ineligible) from serving an elevator call from a floor 80a-80e within the first sector 250a for multiple reasons including but not limited to the first elevator car 103a becoming full, the first elevator car 103 experiencing an opposite stop condition, etc. In an example of an opposite stop condition, if a first elevator car 103a is running up to serve an elevator call from a floor 80c in the first sector 250a to the exit floor 80, and is also serving a car call to floor 80c, and then an elevator call is received from a floor 80e above the floor 80c currently being served, then the first elevator car 103a will be excluded from the elevator call for floor 80e and a second elevator car 103b may be utilized to serve the elevator call for floor 80e.

In an embodiment, the third elevator car 103e may only be moved to the floor of the plurality of floors 80a-80e within the first sector 250a if it is determined that the first elevator car 103a assigned to the first sector 250a will not arrive at the floor of the plurality of floors 80a-80e within the first sector 250a within a first selected time period, the first elevator car 103a assigned to the first sector 250a will arrive at the floor of the plurality of floors 80a-80e within the first sector 250a after the third elevator car 103e, or utilizing the first elevator car 103a will result in a longer time to a final destination in comparison to the third elevator car 103e.

The third elevator car 103e will remain assigned to the third sector 250c. If an elevator call is received from a floor of the plurality of floors within the third sector 250c then the third elevator car 103e is moved to the floor of the plurality of floors within the third sector 250c. The third elevator car 103e may be assigned from the third sector 250c to the first sector 250a in response to at least one of the time of day, the intensity of traffic between the first sector 250a and the third sector 250c, and the intensity of traffic within each of the first sector 250a and the third sector 250c. For example, if it is determined that the first sector 250a is experiencing higher than normal traffic for the first elevator car 103a and the third elevator car 103e to handle, while the third sector 250c is experiencing low traffic, then the third elevator car 103e currently serving the third sector 250c may be assigned to the first sector 250a to help.

The third elevator car 103e may be assigned from the first sector 250a to the second sector 250b in response to at least one of the time of day, the intensity of traffic between the first sector and the second sector, and the intensity of traffic within each of the first sector and the second sector. For example, if it is determined that the second sector 250b is experiencing higher than normal traffic while the first sector 250a and third sector 250c are experiencing low traffic, then the third elevator car 103e currently serving the first sector 250a may be assigned to the second sector 250b to help.

The third elevator car 103e may be assigned to both the first sector 250a and the second sector 250b in response to at least one of the time of day, the intensity of traffic between the first sector and the second sector, and the intensity of traffic within each of the first sector and the second sector. Advantageously, third elevator car 103e may be assigned to both the first sector 250a and the second sector 250b in the event traffic is high in both sectors 250a, 250b.

In the event that an elevator call is received and it is determined that the elevator call was sent from a person designated as a VIP, then any elevator car 103 may be re-assigned from their current sector 250 to handle the elevator call from the VIP.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of operating a building elevator system within a building having a plurality of floors, the method comprising:
controlling a building elevator system comprising a first elevator system having a first elevator car, a second elevator system having a second elevator car, and a third elevator system having a third elevator car, wherein the first elevator car is configured to serve a plurality of floors within a first sector, the second elevator car is configured to serve a plurality of floors within a second sector, and the third elevator car is configured to serve a plurality of floors within the first sector and the second sector;
detecting at least one of a time of day, an intensity of traffic between the first sector and the second sector, and an intensity of traffic within each of the first sector and the second sector; and
assigning the third elevator car to the first sector or the second sector in response to at least one of the time of day, the intensity of traffic between the first sector and the second sector, and the intensity of traffic within each of the first sector and the second sector.

2. The method of claim 1, further comprising:
receiving an elevator call from a floor of the plurality of floors within the first sector; and moving the third elevator car to the floor of the plurality of floors within the first sector.

3. The method of claim 1, further comprising:
receiving an elevator call from a floor of the plurality of floors within the second sector; and
moving the third elevator car to the floor of the plurality of floors within the second sector.

4. The method of claim 1, wherein:
the plurality of floors of the first sector does not include any floors within the plurality of floors of the second sector with the exception of at least one of an exit floor and transfer floor.

5. The method of claim 1, wherein:
the plurality of floors of the first sector includes one or more floors within the plurality of floors of the second sector.

6. The method of claim 1, further comprising:
receiving an elevator call from a floor of the plurality of floors within the first sector;
determining that the first elevator car assigned to the first sector is excluded from serving the floor of the plurality of floors within the first sector; and
moving the third elevator car to the floor of the plurality of floors within the first sector.

7. The method of claim 1, further comprising:
receiving an elevator call from a floor of the plurality of floors within the first sector;
determining that the first elevator car assigned to the first sector will not arrive at the floor of the plurality of floors within the first sector within a first selected time period, the first elevator car assigned to the first sector will arrive at the floor of the plurality of floors within the first sector after the third elevator car, or utilizing the first elevator car will result in a longer time to a final destination in comparison to the third elevator car; and
moving the third elevator car to the floor of the plurality of floors within the first sector.

8. The method of claim 1, further comprising:
receiving an elevator call from a floor of the plurality of floors within the first sector;
determining that the first elevator call was sent from a person designated as a VIP; and
moving the third elevator car to the floor of the plurality of floors within the first sector.

9. The method of claim 1, further comprising:
receiving an elevator call from a floor of the plurality of floors within the first sector;
determining that the first elevator call was sent from a person designated as a VIP;
determining whether the first elevator car or the third elevator car will arrive at the floor of the plurality of floors within the first sector first;
moving the first elevator car to the floor of the plurality of floors within the first sector when it is determined that the first elevator car will arrive at the floor of the plurality of floors within the first sector first; and
moving the third elevator car to the floor of the plurality of floors within the first sector when it is determined that the third elevator car will arrive at the floor of the plurality of floors within the first sector first.

10. The method of claim 3, further comprising:
assigning the third elevator car to the first sector in response to at least one of the time of day, the intensity of traffic between the first sector and the second sector, and the intensity of traffic within each of the first sector and the second sector.

11. The method of claim 2, further comprising:
assigning the third elevator car to the second sector in response to at least one of the time of day, the intensity of traffic between the first sector and the second sector, and the intensity of traffic within each of the first sector and the second sector.

12. A control system of a building elevator system comprising:
a processor;
a memory comprising computer-executable instructions that, when executed by the processor, cause the processor to perform operations, the operations comprising:
controlling a building elevator system comprising a first elevator system having a first elevator car, a second elevator system having a second elevator car, and a third elevator system having a third elevator car, wherein the first elevator car is configured to serve a plurality of floors within a first sector, the second elevator car is configured to serve a plurality of floors within a second sector, and the third elevator car is configured to serve a plurality of floors within the first sector and the second sector;
detecting at least one of a time of day, an intensity of traffic between the first sector and the second sector, and an intensity of traffic within each of the first sector and the second sector; and
assigning the third elevator car to the first sector or second sector in response to at least one of the time of day, the intensity of traffic between the first sector and the second sector, and the intensity of traffic within each of the first sector and the second sector.

13. The control system of claim 12, further comprising:
receiving an elevator call from a floor of the plurality of floors within the first sector; and
moving the third elevator car to the floor of the plurality of floors within the first sector.

14. The control system of claim 11, further comprising:
receiving an elevator call from a floor of the plurality of floors within the second sector; and
moving the third car to the floor of the plurality of floors within the second sector.

15. The control system of claim 12, wherein:
the plurality of floors of the second sector does not include any floors within the plurality of floors within the first sector with the exception of at least one of an exit floor and transfer floor.

16. The control system of claim 12, wherein:
the plurality of floors of the first sector includes one or more floors within the plurality of floors of the second sector.

17. The control system of claim 12, further comprising:
receiving an elevator call from a floor of the plurality of floors within the first sector;
determining that the first elevator car assigned to the first sector is excluded from serving the floor of the plurality of floors within the first sector; and
moving the third elevator car to the floor of the plurality of floors within the first sector.

18. The control system of claim 12, further comprising:
receiving an elevator call from a floor of the plurality of floors within the first sector;
determining that the first elevator car assigned to the first sector will not arrive at the floor of the plurality of floors within the first sector within a first selected time period, the first elevator car assigned to the first sector will arrive at the floor of the plurality of floors within the first sector after the third elevator car, or utilizing the first elevator car will result in a longer time to a final destination in comparison to the third elevator car; and
moving the third elevator car to the floor of the plurality of floors within the first sector.

19. The control system of claim 12, further comprising:
receiving an elevator call from a floor of the plurality of floors within the first sector;
determining that the first elevator call was sent from a person designated as a VIP; and
moving the third elevator car to the floor of the plurality of floors within the first sector.

20. The control system of claim 12, further comprising:
receiving an elevator call from a floor of the plurality of floors within the first sector;
determining that the first elevator call was sent from a person designated as a VIP;
determining whether the first elevator car or the third elevator car will arrive at the floor of the plurality of floors of the first sector first;
moving the first elevator car to the floor of the plurality of floors of the first sector when it is determined that the first elevator car will arrive at the floor of the plurality of floors of the first sector first; and
moving the third elevator car to the floor of the plurality of floors of the first sector when it is determined that the third elevator car will arrive at the floor of the plurality of floors of the first sector first.
